(19) United States
(12) Patent Application Publication
(10) Pub. No.: US 2026/0308187 A1
(43) Pub. Date: Oct. 8, 2026

(54) COMPOUND FOR USE AS ANTI-AGING AGENT IN RUBBER BLENDS, AND VEHICLE TIRE

(71) Applicant: Continental Reifen Deutschland GmbH, Hannover (DE)

(72) Inventors: Andreas Jacob, Hannover (DE); Julian Strohmeier, Einbeck (DE); Thorben Soeren Haubold, Hannover (DE); Philipp Schmidt, Hannover (DE); Frank Fleck, Wennigsen (DE); Carla Recker, Hannover (DE)

(73) Assignee: Continental Reifen Deutschland GmbH, Hannover (DE)

(21) Appl. No.: 19/481,197

(22) PCT Filed: May 15, 2024
(86) PCT No.: PCT/DE2024/200041

§ 371 Date: Nov. 4, 2025

(30) Foreign Application Priority Data
May 23, 2023 (DE) 10 2023 204 803.5

(51) Int. Cl. C07F 9/6584; C08K 5/5397

(52) U.S. Cl. CPC C07F 9/6584; C08K 5/5397

(57) ABSTRACT

A compound of formula (I)

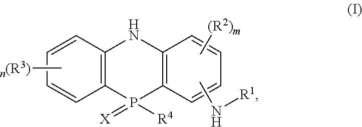

to a rubber mixture containing this compound, to a vehicle tire comprising the rubber mixture in at least one component, to a process for producing this compound and to the use of the compound as an aging stabilizer and/or antioxidant.

The invention relates to a compound of formula (I)

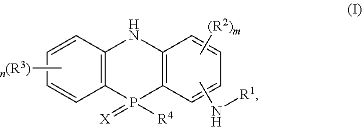

which is further defined in the present text, to a rubber mixture containing this compound, to a vehicle tire comprising the rubber mixture in at least one component, to a process for producing this compound and to the use of the compound as an aging stabilizer and/or antioxidant.

It is known that polymeric compounds, especially rubbers, are employed in vehicle tires and rubber articles distinct from vehicle tires (preferably technical rubber articles). Natural rubber (NR) and synthetic polymers (for example IR, BR, SSBR, ESBR etc.) but also natural and synthetic oils, greases, lubricants and fuels are subject to oxidation reactions which have an adverse effect on the originally desired properties upon prolonged storage and commonly in the target application which is often at elevated temperatures. Depending on the type of the polymer/long-chain compound these undergo shortening (up to liquefaction of the article) or the material/article undergoes a subsequent, undesired hardening.

Aging stabilizers therefore contribute decisively to improved durability of vehicle tires/rubber articles and corresponding compositions.

Typical aging stabilizers include aromatic amines such as for example 6PPD (N-(1,3-dimethylbutyl)-N′-phenyl-p-phenylenediamine), IPPD (N-isopropyl-N′-phenyl-p-phenylenediamine) or SPPD (N-(1-phenylethyl)-N′-phenyl-p-phenylenediamine). These compounds and aging stabilizers in general may react with oxygen, ozone and/or free-radicals, preferably alkyl, alkoxy and alkylperoxy radicals, and scavenge these, thus protecting the polymers/long-chain compounds especially from undesired oxidation and free-radical reactions. Aging stabilizers which react with and scavenge ozone are often also referred to specifically as “antiozonants”.

However, a disadvantage of the aforementioned compounds is the suspicion that they may be carcinogenic and/or harmful to the environment.

A further problem in relation to aging stabilizers is that of undesired blooming. Here, the somewhat poor solubility of the molecules of the aging stabilizer in the surrounding polymer matrix of the tire/rubber article causes them to diffuse to the surface thereof and often form a film there that is usually distinguishable in color from the rest of the article. In the case of vehicle tires, this typically manifests itself in a brown coloring of the otherwise black sidewall. In addition to the aesthetic disadvantages this is also associated with disadvantages in terms of the aging stabilization effect. This is because compounds that have bloomed out have typically been removed from or withdrawn from the vehicle tire by this process. This firstly reduces the total amount of aging stabilizer and also has the effect that further molecules of the aging stabilizer diffuse in the direction of the surface, thus resulting in an ever falling level of protection.

Aging stabilizers in rubber compositions are of course known. JP 6049236 B2 discloses phosphorus-containing aging stabilizers for example.

It is an object of the invention to provide novel compounds which can especially be used as aging stabilizers in vehicle tires and/or other rubber articles distinct from vehicle tires, preferably technical rubber articles, specifically with a lower hazard potential coupled with sufficient solubility in the respective matrix, for example and especially in the polymer. This is intended to ensure continued optimal protection from oxygen, free-radicals and/or (preferably and) ozone and to minimize or even prevent the tendency for blooming while reducing hazardousness to health.

The compound is at the same time intended to ensure at least sufficiently comparable aging stabilization compared to known aromatic amines, such as 6PPD.

The problem is solved by the compound of formula (I) according to the invention:

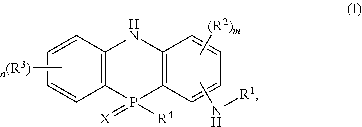

wherein
   R¹ is selected from the group consisting of
      xi) aromatic radicals and
      xii) aliphatic C₃- to C₁₂-radicals,
   R² and R³ are identical or different and independently selected from the group consisting of
      aliphatic C₁- to C₁₂-radicals, aromatic radicals, halogen radicals, cyano radicals, ester radicals, ketone radicals, ether radicals and thioether radicals,
   R⁴ is selected from the group consisting of
      aliphatic C₁- to C₂₀-radicals and aromatic C₅- to C₂₀-radicals,
   X represents oxygen or sulfur, preferably oxygen,
   m is 0 or 1 or 2 or 3 and
   n is 0 or 1 or 2 or 3 or 4.

The compound of formula (I) according to the invention is a phenophosphazinine derivative and has a potentially lower hazard potential compared to known aging stabilizers based on aniline and decomposition products thereof, as first studies on related compounds seem to suggest (Yin Zhi Gang et al. Dyes and Pigments, 2009, 81(2), 137-143). In vehicle tires and rubber articles distinct from vehicle tires (preferably technical rubber articles), this is a decisive advantage since the rubber ingredients are often released through abrasion/other decomposition processes.

The compound of formula (I) according to the invention especially exhibits at least comparable/sufficiently similar aging stabilization (see examples below), especially in rubber mixtures/vehicle tires, compared to the known and commonly used aging stabilizer 6PPD.

The compound of formula (I) according to the invention is preferably an antiozonant, particularly preferably also an antiozonant, i.e. in addition to being capable of reacting with oxygen and/or free-radicals (preferably as mentioned above).

The compound according to the invention of formula (I) is preferably suitable as a substitute for 6PPD, the degradation products of which are especially demonstrably toxic to silver salmon and thus probably also to other aquatic organisms.

The indices m and n describe the number of corresponding groups R² and R³. If m or n are equal to 0 (zero), the radicals R² or R³ are not present and are instead replaced by a hydrogen atom. This is preferably the case independently. R² and R³ are preferably optional in the compounds according to the invention.

It is likewise clear to those skilled in the art that the representation of the bonds of (R²)ₘ and NHR¹ to the 4 possible carbons in the corresponding 6-membered ring and of (R³)ₙ is to be understood as representing bonds to any possible carbon atoms in the adjacent ring. These groups are in each case arranged at any position in the respective ring assigned to them with the exception of course of two or more at the same position simultaneously. In the context of the present invention, the radical NHR¹ is equivalent to N(H)R¹. That is to say that a secondary amine is concerned.

In the context of the present invention, the term “C₃- to C₁₂-radicals” is to be understood as meaning a radical comprising 3 to 12 carbon atoms.

In the context of the present invention, it is generally the case that the invention is not to be bound by a specific mechanism of action or a specific explanation.

The compound according to the invention of formula (I) has an adequate to very good solubility in rubber mixtures, especially for vehicle tires and rubber articles distinct from vehicle tires (especially technical rubber articles). The solubility is preferably further optimized by suitable selection of the radicals R², R³ and/or R⁴. This minimizes or even largely prevents unwanted blooming of this compound which is in turn advantageous for the aging stabilization effect. The less an aging stabilizer blooms, the less of it is intentionally or unintentionally lost via the surface and the less aging stabilizer in turn diffuses after it. This also has significant environmental benefits.

The invention comprises all of the preferred embodiments reflected inter alia in the claims. The invention especially also comprises and discloses embodiments which result from a combination of different features (including with respective different levels of preference for these features) and so a combination of a first feature described as “preferred” with a second feature described for example as “particularly preferred” is also encompassed and disclosed by the invention.

In addition, all information relating to the features of the compounds according to the invention also applies to the process according to the invention for producing the compounds, to the rubber mixture according to the invention containing the compounds and to the use according to the invention.

### The Compound According to the Invention:

Preference is given to a compound according to the invention, wherein said compound has the structure of formula (II):

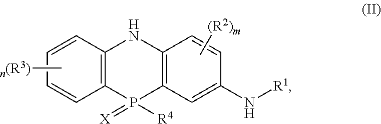

wherein R¹, R², R³, R⁴, X, m and n are defined as claimed in claim 1, preferably as described as preferred in the text.

In the context of the present invention, X represents oxygen (i.e. 0) or sulfur (i.e. S). Particular preference is given to a compound according to the invention, preferably as described as preferred above and/or below, wherein X is oxygen.

The statements made in the present text relating to the compound of formula (I) particularly preferably also relates mutatis mutandis to the compound of formula (II) and vice versa. A compound of formula (II) achieves the object of the invention particularly readily and exhibits adequate to good solubility in rubber mixtures, especially for vehicle tires.

Particular preference is given to a compound according to the invention, preferably as described as preferred above and/or below, wherein n and m are identical or different, preferably identical.

Preference is given to a compound according to the invention, preferably as described as preferred above and/or below, wherein n and m are zero.

In the context of the present invention, R² and R³ are in principle independent of one another. In the compound according to the invention, preferably as described as preferred above and/or below, the radicals R² and R³ are identical or different and independently selected from the group consisting of aliphatic C₁- to C₁₂-radicals, aromatic radicals, halogen radicals, cyano radicals, ester radicals, ketone radicals, ether radicals and thioether radicals.

Preference is given to a compound according to the invention, preferably as described as preferred above and/or below, wherein the aliphatic C₁- to C₁₂-radicals in R² and R³ independently comprise linear partial radicals, branched partial radicals and/or cyclic partial radicals; preferably are linear, branched or cyclic.

Preference is given to a compound according to the invention, preferably as described as preferred above and/or below, wherein the aliphatic C₁- to C₁₂-radicals in R² and R³ are independently saturated or unsaturated, preferably saturated.

Preference is given to a compound according to the invention, preferably as described as preferred above and/or below, wherein the aliphatic radicals in R² and R³ are aliphatic C₁- to C₁₀-radicals, preferably aliphatic C₁- to C₈-radicals, more preferably aliphatic C₁- to C₆-radicals, particularly preferably aliphatic C₁- to C₄-radicals, very particularly preferably aliphatic C₁- to C₂-radicals, preferably methyl and/or ethyl.

In some cases preference is given to a compound according to the invention, preferably as described as preferred above and/or below, wherein the aliphatic C₁- to C₁₂-radicals in R² and R³ independently comprise one or more than one halogen substituent, preferably selected from the group consisting of fluorine, chlorine and bromine.

Preference is given to a compound according to the invention, preferably as described as preferred above and/or below, wherein the aromatic radicals in R² and R³ independently comprise 5 to 20 carbon atoms, preferably 6 to 15 carbon atoms, more preferably 6 to 12 carbon atoms, particularly preferably 6 to 10 carbon atoms, most preferably 6 to 8 carbon atoms.

Preference is given to a compound according to the invention, preferably as described as preferred above and/or below, wherein the aromatic radicals in R² and R³ independently comprise one or more than one halogen substituent, preferably selected from the group consisting of fluorine, chlorine and bromine.

Preference is given to a compound according to the invention, preferably as described as preferred above and/or below, wherein the halogen radicals in R² and R³ are independently selected from the group consisting of fluorine, chlorine and bromine.

Preference is given to a compound according to the invention, preferably as described as preferred above and/or below, wherein the ester radicals, ketone radicals, ether radicals and thioether radicals in R² and R³ independently comprise 1 to 20 carbon atoms, preferably 1 to 16 carbon atoms, more preferably 1 to 12 carbon atoms, particularly preferably 1 to 9 carbon atoms, more particularly preferably 1 to 7 carbon atoms, most preferably 1 to 5 carbon atoms. In some cases it is preferable when the aforementioned upper limits of carbon atoms are combined with a lower limit of at least 2 carbon atoms.

Preference is given to a compound according to the invention, preferably as described as preferred above and/or below, wherein R² and R³ independently comprise at most 12 carbon atoms, preferably 10 carbon atoms, particularly preferably 6 carbon atoms, very particularly preferably 4 carbon atoms. This is to be understood as meaning for example that R³ has at most 10 carbon atoms while R² has at most 6 carbon atoms.

The recited radicals R² and R³ are particularly preferably already attached through selection of suitable starting compounds.

The number and type of substituents R² and R³ if selected has a decisive influence on the solubility of the compound according to the invention within the rubber mixture according to the invention and the vehicle tires according to the invention. This preferably also applies, alternatively or in addition, to R⁴.

Radical R⁴ is selected from the group consisting of aliphatic C₁- to C₂₀-radicals and aromatic C₅- to C₂₀-radicals.

Preference is given to a compound according to the invention, preferably as described as preferred above and/or below, wherein R⁴ is an aromatic C₅- to C₁₈-radical, preferably an aromatic C₅- to C₁₆-radical, more preferably an aromatic C₅- to C₁₄-radical, particularly preferably an aromatic C₆- to C₁₂-radical, very particularly preferably an aromatic C₆- to C₁₀-radical.

It is very particularly preferable when the aromatic C₅- to C₂₀-radical is phenyl or benzyl.

Preference is given to a compound according to the invention, wherein R⁴ is an aliphatic C₁- to C₁₈-radical, preferably an aliphatic C₂— to C₁₆-radical, more preferably an aliphatic C₃- to C₁₄-radical, particularly preferably an aliphatic C₄- to C₁₂-radical, very particularly preferably an aliphatic C₅- to C₁₀-radical. This preferably applies alternatively or in combination with the aromatic C₅- to C₂₀-radicals in R⁴ and the preferred embodiments thereof.

Particular preference is given to a compound according to the invention, preferably as described as preferred above and/or below, wherein R⁴ is a C₁- to C₂₀-alkyl radical, preferably a C₁- to C₁₈-alkyl radical, more preferably a C₂— to C₁₆-alkyl radical, particularly preferably a C₃- to C₁₄-alkyl radical, very particularly preferably a C₄- to C₁₂-alkyl radical, most preferably a C₅- to C₁₀-alkyl radical. This too preferably applies alternatively or in combination with the aromatic C₅- to C₂₀-radicals in R⁴ and the preferred embodiments thereof.

Very particular preference is given to a compound according to the invention, wherein R⁴ is heptyl, octyl, nonyl, benzyl or phenyl.

In the compound according to the invention, the radical R¹ is selected from the group consisting of
xi) aromatic radicals and
xii) aliphatic C₃- to C₁₂-radicals.

In some cases preference is given to a compound according to the invention, preferably as described as preferred above and/or below, wherein the aromatic radicals in xi) encompass a substituent selected from the group consisting of alkyl radicals, halogen radicals, cyano radicals, ester radicals, ketone radicals, ether radicals and thioether radicals; particularly preferably alkyl radicals, ester radicals, ketone radicals, ether radicals and thioether radicals. In other cases, and particularly preferably, the aromatic radicals in xi) bear none of the aforementioned substituents, preferably are not substituted at all. The substituent is preferably in the meta- or para-position. The substituent is particularly preferably not in the ortho position. This is particularly advantageous for the longevity of the aging stabilizer.

Preference is given to a compound according to the invention, preferably as described as preferred above and/or below, wherein the aromatic radicals in xi) comprise 5 to 20 carbon atoms, preferably 6 to 15 carbon atoms, more preferably 6 to 10 carbon atoms, most preferably 6 to 8 carbon atoms.

Particular preference is given to a compound according to the invention, preferably as described as preferred above and/or below, wherein the aromatic radicals in xi) comprise phenyl radicals (i.e. —C₆H₅), alpha-methylbenzyl (i.e. —CH₂(CH₃)—C₆H₅) and/or benzyl radicals (i.e. —CH₂—C₆H₅), particularly preferably phenyl radicals.

Preference is given to a compound according to the invention, preferably as described as preferred above and/or below, wherein the aliphatic C₃- to C₁₂-radicals in xii) comprise linear partial radicals, branched partial radicals and/or cyclic partial radicals; preferably are linear, branched or cyclic, most preferably are branched.

Preference is given to a compound according to the invention, preferably as described as preferred above and/or below, wherein the aliphatic C₃- to C₁₂-radicals in xii) are saturated or unsaturated, preferably saturated.

Particular preference is given to a compound according to the invention, preferably as described as preferred above and/or below, wherein in xii) the aliphatic radicals are aliphatic C₃- to C₁₀-radicals, preferably aliphatic C₄- to C₈-radicals, more preferably aliphatic C₅- to C₇-radicals.

Preference is given to a compound according to the invention, preferably as described as preferred above and/or below, wherein R¹ comprises a tertiary carbon atom with which it is bonded to the nitrogen atom (N). The nitrogen atom (N) is preferably a secondary nitrogen atom.

In the context of the present invention, the term “tertiary carbon atom” is to be understood as meaning a carbon atom having only one hydrogen atom bonded to it. Compared to secondary and quaternary carbon atoms this results in a particularly good protective effect, preferably in rubber mixtures (particularly preferably for vehicle tires and/or other rubber articles distinct from vehicle tires (especially technical rubber articles)). An optimized reactivity in the context of the mechanisms relevant for aging stabilization is especially achieved, wherein undesired side reactions are avoided.

Particular preference is given to a compound according to the invention, wherein R¹ is a branched or cyclic alkyl radical, preferably in each case comprising 3 to 12 carbon atoms, preferably in each case comprising 3 to 8 carbon atoms, particularly preferably in each case comprising 4 to 7 carbon atoms. These are particularly preferably saturated. For cyclic alkyl radicals it is preferably the case that they comprise at least 5 carbon atoms, preferably at least 6. This minimum number is preferably combined with the aforementioned upper limits for carbon atoms.

Very particular preference is given to a compound according to the invention, preferably as described as preferred above and/or below, wherein R¹ is 1,3-dimethylbutyl, phenyl, benzyl or cyclohexyl, preferably 1,3-dimethylbutyl. This achieves a particularly good protective effect in rubber mixtures, particularly preferably for vehicle tires and rubber articles distinct from vehicle tires (preferably technical rubber articles).

Very particular preference is given to a compound according to the invention, wherein said compound has the structure of formula (III):

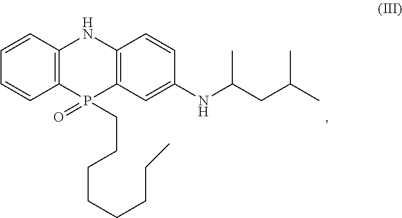 [SMILES: CCCCCCCCP1(=O)c2ccccc2Nc2ccc(NC(C)CC(C)C)cc21]

The compound according to formula (III) has a sufficient solubility in polymers, preferably in rubber mixtures, particularly preferably in rubber mixtures for vehicle tires and rubber articles distinct from vehicle tires (preferably technical rubber articles). Furthermore, the compound according to formula (III) may be produced in a comparatively simple, energy-efficient and cost-saving manner and, compared to 6PPD, exhibits a sufficiently good protective effect (see examples below). According to IUPAC nomenclature the compound according to the invention of formula (III) is also referred to as
2-(1,3-dimethylbutylamino)-10-octyl-5H-phenophosphazinine-10-oxide.

### Rubber Mixture Comprising a Compound According to Formula (I):

The present invention further relates to a rubber mixture containing the compound according to the invention as described above (preferably as described as preferred above and/or below, particularly preferably comprising a compound according to formula (III)), preferably comprising one or more than one diene rubber. The rubber mixture comprises one or more than one compound according to the invention, wherein it is preferable when at least one rubber is a diene rubber.

The foregoing relating to the compound according to the invention, especially as described as preferred above, preferably also applies mutatis mutandis to the rubber mixture according to the invention.

The rubber mixture according to the invention thus contains at least one rubber. The rubber mixture according to the invention is in principle any rubber mixture in which the compounds according to the invention act as aging stabilizers and/or antiozonants with low toxicity. The rubber mixture according to the invention comprises one or more than one rubber.

Preference is given to a rubber mixture according to the invention, preferably as described as preferred above and/or below, comprising one or more than one compound according to the invention (preferably as described as preferred above), wherein these are preferably the only phenophosphazinine oxides in the rubber mixture.

Preference is given to a rubber mixture according to the invention, preferably as described as preferred above and/or below, comprising a total amount of the compound according to the invention of 0.1 to 10 phr, preferably of 0.3 to 8 phr, more preferably of 0.6 to 6 phr, particularly preferably of 0.8 to 4.5 phr, very particularly preferably of 1 to 3 phr.

The unit “phr” (parts per hundred parts of rubber by weight) used in the context of the present invention is the unit of quantity for mixture recipes that is customary in the rubber industry. The dosage of the parts by weight is based on 100 parts by weight of the total mass of all high molecular weight (M_{w} greater than 20 000 g/mol) rubbers present in the mixture.

The rubber mixture according to the invention, preferably as described as preferred above and/or below, preferably comprises one or more than one diene rubber. Diene rubbers are typically understood as meaning rubbers that are formed by polymerization or copolymerization of dienes and/or cycloalkenes and thus have C═C double bonds either in the main chain or in the side groups.

Preference is given to a rubber mixture according to the invention, preferably as described as preferred above and/or below, wherein the diene rubber is selected from the group consisting of natural polyisoprene (NR), synthetic polyisoprene (IR), epoxidized polyisoprene (ENR), butadiene rubber (BR), butadiene-isoprene rubber, solution-polymerized styrene-butadiene rubber (SSBR), emulsion-polymerized styrene-butadiene rubber (ESBR), styrene-isoprene rubber, liquid rubbers having a molecular weight M_{w} of more than 20 000 g/mol, butyl rubber (IIR), halobutyl rubber (XIIR), polynorbornene, isoprene-isobutylene copolymer, ethylene-propylene-diene rubber, nitrile rubber, chloroprene rubber, acrylate rubber, fluoro rubber, silicone rubber, polysulfide rubber, epichlorohydrin rubber, styrene-isoprene-butadiene terpolymer, hydrogenated acrylonitrile butadiene rubber and hydrogenated styrene-butadiene rubber.

In the context of the present invention, the term “natural rubber” is to be understood as meaning naturally occurring rubber obtained from Hevea rubber trees and/or “non-Hevea” sources. Preferred non-Hevea sources are guayule shrubs and dandelion. A particularly preferred dandelion is TKS (Taraxacum Kok-saghyz; Russian dandelion).

Particular preference is given to a rubber mixture according to the invention, preferably as described as preferred above and/or below, wherein the diene rubber is selected from the group consisting of natural polyisoprene (NR), synthetic polyisoprene (IR), butadiene rubber (BR), solution-polymerized styrene-butadiene rubber (SSBR), emulsion-polymerized styrene-butadiene rubber (ESBR), butyl rubber (IIR) and halobutyl rubber (XIIR).

Very particular preference is given to a rubber mixture according to the invention, preferably as described as preferred above and/or below, wherein the diene rubber is selected from the group consisting of natural polyisoprene (NR), synthetic polyisoprene (IR), butadiene rubber (BR), solution-polymerized styrene-butadiene rubber (SSBR) and emulsion-polymerized styrene-butadiene rubber (ESBR).

Nitrile rubber, hydrogenated acrylonitrile-butadiene rubber, chloroprene rubber, butyl rubber (IIR), halobutyl rubber (XIIR) and/or ethylene-propylene-diene rubber are preferably employed in the production of rubber articles which are distinct from vehicle tires (but are otherwise typically considered technical rubber articles), preferably for straps, drive belts, hoses, belts and/or shoe soles. The mixture compositions known to those skilled in the art for these rubbers, which are specific in terms of fillers, plasticizers, vulcanization systems, and additives, are used with preference here.

Polyisoprene preferably encompasses cis-1,4-polyisoprene and/or 3,4-polyisoprene. This preferably applies irrespective of whether natural or synthetic polyisoprene is concerned. Preference is given to cis-1,4-polyisoprene particularly preferably having a cis-1,4 content greater than 90% by weight. Such a polyisoprene is preferably obtained by stereospecific polymerization in solution with Ziegler-Natta catalysts or using finely divided lithium alkyls. Furthermore, natural rubber (NR) is also such a cis-1,4-polyisoprene. Particular preference is therefore given to natural rubber (NR) comprising cis-1,4-polyisoprene, preferably having a cis-1,4 content of not less than 99% by weight.

Preference is in some cases given to a rubber mixture according to the invention, preferably as described as preferred above and/or below, comprising one or more than one natural polyisoprene (NR) and one or more than one synthetic polyisoprene (IR). A mixture of polyisoprene is thus preferably present.

Particular preference is in some cases given to a rubber mixture according to the invention, preferably as described as preferred above and/or below, comprising one or more than one natural polyisoprene (NR), preferably in a total amount of 56 to 130 phr, particularly preferably of 80 to 120 phr, very particularly preferably of 90 to 110 phr, more preferably of 95 to 100 phr. Such a rubber mixture especially shows optimized tear properties and abrasion properties coupled with good processibility and reversion stability. A further preferred total amount is in the range from 56 to 100 phr, preferably from 80 to 100 phr, more preferably from 90 to 100 phr.

Preference is in some cases given to a rubber mixture according to the invention, preferably as described as preferred above and/or below, comprising one or more than one natural polyisoprene (NR), wherein the total amount thereof is significantly less than 100 phr. In these cases, the rubber mixture additionally comprises one or more than one rubber distinct from natural polyisoprene, preferably a further diene rubber, particularly preferably selected from the group consisting of synthetic polyisoprene (IR), butadiene rubber (BR), solution-polymerized styrene-butadiene rubber (SSBR) and emulsion-polymerized styrene-butadiene rubber (ESBR). Particular preference is in these cases given to a rubber mixture according to the invention comprising one or more than one natural polyisoprene (NR) in a total amount of 5 to 55 phr, preferably of 5 to 35 phr, more preferably of 5 to 25 phr, very particularly preferably of 5 to 20 phr. Such a rubber mixture especially exhibits good processibility and reversion stability and optimized tear properties and optimal rolling resistance characteristics.

Preference is in some cases given to a rubber mixture according to the invention, preferably as described as preferred above and/or below, comprising at least one butadiene rubber (BR, polybutadiene). Preference is given to a butadiene rubber comprising a high-cis and/or a low-cis type, wherein polybutadiene having a cis content of not less than 90% by weight is referred to as high-cis type and polybutadiene having a cis content of less than 90% by weight is referred to as low-cis type. A particularly preferred low-cis type comprises Li-BR (lithium-catalyzed butadiene rubber), preferably having a cis content of 20% to 50% by weight. Particular preference is given to a high-cis type since this achieves particularly good properties, especially a low hysteresis of the rubber mixture.

Preference is in some cases given to a rubber mixture according to the invention, preferably as described as preferred above and/or below, wherein the butadiene rubber is end-group functionalized and/or functionalized along the polymer chains using one or more than one functional group. It is preferable when the one or more than one functional group is independently selected from the group consisting of hydroxy groups, ethoxy groups, epoxy groups, siloxane groups, amino groups, aminosiloxane groups, carboxy groups, phthalocyanine groups and silane-sulfide groups. However, the selection of the functional group is preferably not limited to the aforementioned groups. In some cases, the functional group preferably comprises one or more metals.

Preference is given to a rubber mixture according to the invention, preferably as described as preferred above and/or below, comprising the one or more than one butadiene rubber in a total amount of 10 to 80 phr, preferably of 12 to 50 phr, particularly preferably of 15 to 40 phr. This achieves particularly good tear and abrasion properties of the rubber mixture according to the invention and optimal braking characteristics.

Preference is in some cases given to a rubber mixture according to the invention, preferably as described as preferred above and/or below, comprising at least one styrene-butadiene rubber (styrene-butadiene copolymer). Preference is given to a styrene-butadiene rubber comprising one or more than one solution-polymerized styrene-butadiene rubber (SSBR) and/or one or more than one emulsion-polymerized styrene-butadiene rubber (ESBR). In the context of the present invention, the terms “styrene-butadiene rubber” and “styrene-butadiene copolymer” are used synonymously. In some cases, preference is given to a rubber mixture according to the invention, wherein the styrene-butadiene rubber is end-group functionalized and/or functionalized along the polymer chains by means of one or more than one functional group. For preferred functional groups, the foregoing relating to the butadiene rubber applies correspondingly.

Preference is given to a rubber mixture according to the invention, preferably as described as preferred above and/or below, comprising the at least one styrene-butadiene rubber (SSBR) in a total amount of 10 to 80 phr, preferably of 30 to 75 phr, particularly preferably of 50 to 70 phr. Particular preference is given to a rubber mixture according to the invention comprising one or more than one solution-polymerized styrene-butadiene rubber (SSBR) which is additionally present in a total amount of 10 to 80 phr, preferably of 30 to 75 phr, particularly preferably of 50 to 70 phr. This achieves particularly good rolling resistance properties of the rubber mixture of the invention. It is particularly preferable to employ the solution-polymerized styrene-butadiene rubber (SSBR) in combination with one or more than one further rubber. This typically achieves an improved and balanced profile of properties.

In addition to one or more than one compound according to the invention and at least one rubber, the rubber mixture according to the invention preferably comprises additional ingredients, preferably at least one filler.

Preference is given to a rubber mixture according to the invention, preferably as described as preferred above and/or below, additionally comprising one or more than one filler, preferably in a total amount of 30 to 500 phr, preferably of 50 to 400 phr, more preferably of 80 to 300 phr. A particularly preferred filler is a reinforcing filler particularly preferably selected from the group consisting of carbon blacks and silicon dioxides.

Suitable carbon blacks in principle include any carbon black types known to those skilled in the art. The carbon black is preferably selected from the group consisting of industrial carbon black and pyrolysis carbon black, wherein an industrial carbon black is preferred.

It is preferable when the carbon black has an iodine number according to ASTM D 1510 (also known as the iodine adsorption number) in a range from 30 to 250 g/kg, preferably from 35 to 215 g/kg, particularly preferably from 40 to 180 g/kg and very particularly preferably from 45 to 140 g/kg, and/or a DBP number according to ASTM D 2414 in a range from 30 to 200 ml/100 g, preferably from 70 to 170 ml/100 g, particularly preferably from 90 to 140 ml/100 g. The DBP number according to ASTM D 2414 determines the specific absorption volume of a carbon black or of a light-colored filler using dibutyl phthalate. The use of such a carbon black in the rubber mixture according to the invention, especially for vehicle tires, typically ensures a best possible compromise between abrasion resistance and heat buildup, which in turn influences the environmentally relevant rolling resistance. Particular preference is given to a carbon black having an iodine number in the range from 80 to 110 g/kg and a DBP number in the range from 100 to 130 ml/100 g. Very particular preference is given to a carbon black of the type N339.

Preference is in some cases given to a rubber mixture according to the invention, preferably as described as preferred above and/or below, wherein the carbon black in the rubber mixture is present in a total amount in the range from 0.1 to 60 phr, preferably from 3 to 40 phr, particularly preferably from 4 to 30 phr, very particularly preferably from 5 to 15 phr. In these amounts, the carbon black is typically present as a complementary filler in combination with a primary filler, preferably one or more than one silicon dioxide, particularly preferably silica.

In other cases, preference is given to a rubber mixture according to the invention, preferably as described as preferred above and/or below, wherein the carbon black is present in the rubber mixture in a total amount in the range from 30 to 300 phr, preferably from 35 to 200 phr, particularly preferably from 40 to 100 phr. In these amounts, carbon black is especially present as the sole filler or as a primary filler (more than 50% by weight based on total filler amount, preferably in combination with relatively small amounts of silica).

The silicon dioxide is preferably amorphous silicon dioxide and/or pyrogenic silicon dioxide. A particularly preferred amorphous silicon dioxide comprises precipitated silica, which is also referred to as precipitated silicon dioxide.

Particular preference is given to amorphous silicon dioxide, preferably precipitated silica, having a nitrogen surface area (BET surface area) (according to DIN ISO 9277 and DIN 66132) in the range from 35 to 400 m²/g, preferably from 50 to 350 m²/g, particularly preferably from 85 to 320 m²/g, very particularly preferably from 120 to 235 m²/g, and/or (preferably and) having a CTAB surface area (according to ASTM D 3765) in the range from 30 to 400 m²/g, preferably from 50 to 330 m²/g, particularly preferably from 80 to 300 m²/g, very particularly preferably from 115 to 200 m²/g. Such silicon dioxide results, for example in rubber mixtures for tire treads, in particularly good physical properties of the vulcanizates. Advantages in mixture processing by way of a reduction in mixing time can also arise here while retaining the same product properties, leading to improved productivity. Particular preference is given to a silica of the type Ultrasil® VN3 (trade name) from Evonik, and to highly dispersible silicas (so-called HD silicas). Preferred highly dispersible silicas include Zeosil® 1165 MP from Solvay.

In some cases preference is given to a rubber mixture according to the invention, preferably as described as preferred above and/or below, comprising at least one silica, preferably in a total amount in the range from 30 to 500 phr, more preferably from 50 to 400 phr, particularly preferably from 80 to 300 phr. In these amounts, silica is especially present as the sole filler or as a primary filler (more than 50% by weight based on total filler amount; preferably in combination with relatively small amounts of carbon black).

In some cases, particular preference is given to a rubber mixture according to the invention, preferably as described as preferred above and/or below, comprising at least one silica, preferably in a total amount in the range from 5 to 100 phr, more preferably from 7 to 80 phr, particularly preferably from 10 to 60 phr. In these amounts, silica is typically present as a complementary filler in combination with a primary filler, preferably a carbon black.

Particular preference is given to a rubber mixture according to the invention, preferably as described as preferred above and/or below, comprising at least one silica and at least one carbon black, wherein the total amount of silica is in the range from 50 to 300 phr, preferably from 80 to 200 phr, and the total amount of carbon black is in the range from 5 to 60 phr, preferably from 7 to 40 phr.

The rubber mixture according to the invention, preferably as described as preferred above and/or below, preferably comprises additional fillers, i.e. fillers which are distinct from/do not comprise carbon blacks, silicon dioxides and silicas. These additional fillers preferably comprise additionally reinforcing fillers and/or non-reinforcing fillers.

Preferred non-reinforcing fillers comprise aluminosilicates, kaolin, chalk, starch, magnesium oxide, titanium dioxide, rubber gels and/or fibers. Preferred fibers comprise aramid fibers, glass fibers, carbon fibers and/or cellulose fibers.

Preferred additionally reinforcing fillers comprise carbon nanotubes, graphite, graphene and/or so-called “carbon silica dual-phase fillers”. The carbon nanotubes preferably comprise carbon nanotubes which are unmodified and/or modified with functional groups, wherein preferred functional groups are selected from the group consisting of hydroxy, carboxy and carbonyl groups.

In the context of the present invention, zinc oxide is not one of the fillers within the meaning of the present invention.

Preference is given to a rubber mixture according to the invention, preferably as described as preferred above and/or below, comprising one or more than one further additive. Such additives are typically customary additives in the typical amounts that are preferably added in at least one main mixing stage during production of the rubber mixture.

The one or more than one further additive preferably comprises:
a) aging stabilizers known from the prior art and distinct from compounds of formula (I) according to the invention and from any other compounds according to the invention; preferably comprising para-phenylenediamines and/or dihydroquinolines; particularly preferably selected from the group consisting of N-phenyl-N′-(1,3-dimethylbutyl)-p-phenylenediamine (6PPD), N,N′-diphenyl-p-phenylenediamine (DPPD), N-(1-phenylethyl)-N′-phenyl-p-phenylenediamine (SPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD), and 2,2,4-trimethyl-1,2-dihydroquinoline (TMQ);
b) an activator, preferably comprising zinc compounds (including zinc complexes) and/or fatty acids, particularly preferably comprising zinc oxide, stearic acid and/or zinc ethylhexanoate;
c) agents for bonding of fillers (especially for carbon black and silica), preferably comprising S-(3-aminopropyl)thiosulfuric acid, the metal salts thereof (particularly for bonding to carbon black) and/or silane coupling agents (particularly for bonding to silicon dioxide, especially to silica);
d) antiozonant waxes;
e) resins, preferably tackifying resins;
f) mastication aids, preferably comprising 2,2′-dibenzamidodiphenyl disulfide (DBD);
g) process auxiliaries, preferably comprising fatty acid esters and/or metal soaps, wherein preferred metal soaps comprise zinc soaps and/or calcium soaps, and/or
h) plasticizers, preferably comprising oils (preferably comprising aromatic, naphthenic and/or paraffinic mineral oils), resins and/or liquid polymers, particularly preferably comprising MES (mild extraction solvate), DAE (distillate aromatic extracts), RAE (residual aromatic extract), TDAE (treated distillate aromatic extract), rubber-to-liquid oils (RTL), biomass-to-liquid oils (BTL) (preferably having a content of polycyclic aromatics of less than 3% by weight according to method IP 346), triglycerides (preferably rapeseed oil), a factice, hydrocarbon resins and/or liquid polymers having an average molecular weight (determination by GPC=gel permeation chromatography based on BS ISO 11344:2004) between 500 and 20 000 g/mol. When using mineral oil, this is preferably selected from the group consisting of DAE (distillate aromatic extracts), RAE (residual aromatic extract), TDAE (treated distillate aromatic extracts), MES (mild extracted solvents) and naphthenic oils.

Particular preference is in most cases given to a rubber mixture according to the invention, preferably as described as preferred above and/or below, which is substantially free from, preferably does not comprise, N-Phenyl-N′-(1,3-dimethylbutyl)-p-phenylenediamine (6PPD), N,N′-diphenyl-p-phenylenediamine (DPPD), N-(1-phenylethyl)-N′-phenyl-p-phenylenediamine (SPPD), N,N′-ditolyl-p-phenylenediamine (DTPD), N-(1,4-dimethylpentyl)-N′-phenyl-p-phenylenediamine (7PPD), N-isopropyl-N′-phenyl-p-phenylenediamine (IPPD), and is optionally also free from 2,2,4-trimethyl-1,2-dihydroquinoline (TMQ), more preferably is substantially free from, preferably does not comprise, para-phenylenediamines and is optionally also free from dihydroquinolines, most preferably is substantially free from, preferably does not comprise, aging stabilizers distinct from compounds according to the invention (i.e. customary aging stabilizers known from the prior art). It is therefore particularly preferable for the rubber mixture according to the invention to contain as the sole aging stabilizer one or more than one compound according to the invention, preferably as described as preferred above. In the context of the present invention, “substantially free from” is to be understood as meaning a quantitative upper limit of 0.1 phr, preferably a total amount in the range from 0 phr to 0.1 phr, particularly preferably from 0.0001 phr to 0.1 phr. The amount zero (0), i.e. “does not comprise”, is particularly preferable. These very preferred small amounts, including zero (0) phr, make it possible to achieve a comparable protective effect at significantly reduced toxicity. The compound according to the invention replaces the recited typically employed para-phenylenediamines known in the prior art. In some other cases, preference is given to a rubber mixture according to the invention in which aging stabilizers distinct from compounds according to the invention (particularly para-phenylenediamines) have been at least partially replaced by one or more than one compound according to the invention, preferably to an extent of 50% by weight or more. This already achieves the advantage according to the invention at least partially, albeit not to an optimal extent.

As defined above, the additional absence of dihydroquinolines, preferably 2,2,4-trimethyl-1,2-dihydroquinoline (TMQ), is optional, i.e. is desired in some cases and undesired in other cases. In some cases, preference is given to a rubber mixture according to the invention, preferably as described as preferred above and/or below, comprising (irrespective of whether para-phenylenediamines are present or not) one or more than one dihydroquinoline, preferably 2,2,4-trimethyl-1,2-dihydroquinoline (TMQ). It is preferable when the rubber mixture according to the invention comprises dihydroquinoline, preferably 2,2,4-trimethyl-1,2-dihydroquinoline (TMQ), in a total amount in the range from 0.1 to 3 phr, preferably from 0.5 to 1.5 phr.

Antiozonant waxes (see d) above) are considered separately and are preferably present in the rubber mixture according to the invention irrespective of whether aging stabilizers according to a) are present or not.

The silane coupling agents (see c) above) preferably include all types known to those skilled in the art. The rubber mixture according to the invention, preferably as described as preferred above and/or below, preferably comprises one or more than one silane coupling agent. In some cases the rubber mixture according to the invention preferably comprises a mixture of different silanes.

Silane coupling agents react with the surface silanol groups of the silicon dioxide (especially of the silica) or other polar groups either during the mixing of the rubber/the rubber mixture (in situ) or already before addition thereof to the rubber during a pretreatment (premodification).

Preferred silane coupling agents comprise bifunctional organosilanes which have at least one alkoxy, cycloalkoxy or phenoxy group as a leaving group on the silicon atom and as a further functionality comprise a group which (optionally after dissociation) can undergo a chemical reaction with the double bonds of the polymer. Preferred groups comprise —SCN, —SH, —NH₂ and/or —Sₓ— (where x=2 to 8). Silanes having an —SH group are typically also referred to as mercaptosilanes. Preferred mercaptosilanes comprise blocked mercaptosilanes, preferably according to WO 99/09036 A1.

Particularly preferred silane coupling agents comprise 3-mercaptopropyltriethoxysilane, 3-thiocyanatopropyltrimethoxysilane, 3,3′-bis(triethoxysilylpropyl) polysulfides having 2 to 8 sulfur atoms (particularly preferably 3,3′-bis(triethoxysilylpropyl)tetrasulfide (TESPT) and/or the disulfide thereof (TESPD)) and/or mixtures of the sulfides preferably each having a different number of sulfur atoms. In some cases preference is given to TESPT, particularly preferably in the form of a mixture with industrial carbon black (trade name X50S® from Evonik).

Preferred silane coupling agents also include, alternatively or in addition, those according to WO 2008/083241 A1, WO 2008/083242 A1, WO 2008/083243 A1 and/or WO 2008/083244 A1. Further preferred silane coupling agents comprise, alternatively or in addition, silanes marketed by Momentive, USA in a number of variants under the name NXT (preferably 3-octanoylthio-1-propyltriethoxysilane) and/or silanes marketed by Evonik Industries under the name VP Si 363®.

Preference is given to a rubber mixture according to the invention, preferably as described as preferred above and/or below, wherein the one or more than one further additive is present in a total amount in the range from 3 to 150 phr, preferably from 4 to 100 phr, more preferably from 5 to 80 phr.

Preference is given to a rubber mixture according to the invention, preferably as described as preferred above and/or below, comprising one or more than one activator (see b) above), preferably a zinc compound, particularly preferably zinc oxide. There is preferably no limit on the types of zinc oxide. Preference is given to a granulate and/or a powder. The zinc oxide preferably has a BET surface area up to 100 m²/g, preferably in a range from 1 to 100 m²/g. In some cases preference is given to a zinc oxide, wherein the BET surface area is less than 10 m²/g. In other cases preference is given to a zinc oxide, wherein the BET surface area is in the range from 10 to 100 m²/g, particular preference being given to so-called “nano-zinc oxides”.

Preference is given to a rubber mixture according to the invention, preferably as described as preferred above and/or below, wherein said mixture is vulcanized or partially vulcanized, preferably vulcanized. This means that it is preferably employed in a vulcanized or partially vulcanized state, particularly preferably in a vehicle tire or in rubber articles distinct from vehicle tires (preferably technical rubber articles). In the context of the present invention the terms “vulcanized” and “crosslinked” are used synonymously. The rubber mixture according to the invention is thus preferably a crosslinked rubber mixture. However, it is naturally clear to those skilled in the art that the rubber mixture is typically not in vulcanized form until definitive processing.

The vulcanization of the rubber mixture according to the invention is preferably carried out in the presence of sulfur and/or sulfur donors, preferably with co-use of vulcanization accelerators, wherein some vulcanization accelerators are preferably also sulfur donors.

Preference is given to a rubber mixture according to the invention, preferably as described as preferred above and/or below, comprising sulfur/or one or more than one sulfur donor. There is no particular limitation with regard to the sulfur donors and so all sulfur donors known to those skilled in the art are in principle contemplated, provided they supply sulfur in an appropriate form under the prevailing conditions.

Preference is given to a rubber mixture according to the invention comprising (alternatively or in addition to a sulfur donor) one or more than one vulcanization accelerator.

Preferred vulcanization accelerators comprise thiazole accelerators, mercapto accelerators, sulfenamide accelerators, thiocarbamate accelerators, thiuram accelerators, thiophosphate accelerators, thiourea accelerators, xanthate accelerators and/or guanidine accelerators. Particular preference is given to one or more than one sulfenamide accelerator and/or one or more than one guanidine accelerator, very particularly one or more than one accelerator selected from the group consisting of N-cyclohexyl-2-benzothiazolesufenamide (CBS), N,N-dicyclohexylbenzothiazol-2-sulfenamide (DCBS), benzothiazyl-2-sulfenmorpholide (MBS), N-tert-butyl-2-benzothiazylsulfenamide (TBBS) and diphenylguanidine (DPG).

Preference is given to a rubber mixture according to the invention, preferably as described as preferred above and/or below, comprising one or more than one vulcanization retarder. The presence of a vulcanization retarder for example contributes to better balanced progress of the vulcanization.

The rubber mixture according to the invention is preferably produced or provided, particularly preferably produced. This is preferably done by processes customary in the rubber industry in which initially in one or more than one mixing stage a base mixture comprising all constituents except (i.e. with the exception of) the vulcanization system is provided, wherein the vulcanization system comprises the sulfur and the vulcanization-influencing compounds, i.e. preferably the total amount of sulfur, sulfur donor, vulcanization accelerator and vulcanization retarder. Addition of the vulcanization system in a final mixing stage produces a finished mixture which is preferably subjected to further processing by extrusion and/or calendering and brought into the desired shape. The shape thus achieved preferably determines the subsequent use, such as for example in a vehicle tire.

Preference is given to a rubber mixture according to the invention for use in a vulcanizate.

Greater preference is given to a rubber mixture according to the invention for use in a vehicle tire, preferably in an external or internal component of a vehicle tire, preferably in an external component.

Preference is given to a rubber mixture according to the invention, preferably as described as preferred above and/or below, comprising one or more than one strength member preferably comprising fibers, fabrics and/or cords.

### Vehicle Tire Comprising the Rubber Mixture According to the Invention:

The present invention further relates to a vehicle tire, preferably a pneumatic vehicle tire, which comprises the rubber mixture according to the invention as described hereinabove, preferably as described as preferred above, in at least one component, preferably in at least one external component, wherein the external component is preferably a tread, a sidewall and/or a flange profile.

The foregoing relating to the compound according to the invention and the rubber mixture according to the invention, in each case including preferred embodiments, preferably also applies mutatis mutandis to the vehicle tire according to the invention.

The vehicle tire according to the invention is preferably vulcanized, i.e. not a green vehicle tire. The vulcanized vehicle tire preferably comprises at least in one component a vulcanizate of at least one rubber mixture according to the invention. It is known to those skilled in the art that most compounds, for example the rubbers present, are present in chemically modified form or may only be present at all either already after mixing or only after vulcanization.

The vehicle tire according to the invention, preferably as described as preferred above and/or below, preferably comprises a pneumatic vehicle tire and/or a solid rubber tire.

The vehicle tire according to the invention, preferably as described as preferred above and/or below, is preferably selected from the group consisting of industrial and construction site vehicle tires, truck tires, passenger car tires and two-wheeler tires.

Particular preference is given to a vehicle tire according to the invention, preferably as described as preferred above and/or below, which comprises the rubber mixture according to the invention in two, three, or more than three components.

### Use of the Compound According to the Invention and Rubber Mixture According to the Invention:

The present invention very generally relates to a use of the compound according to the invention, preferably as described as preferred above, as an aging stabilizer and/or (preferably and) antioxidant in a rubber mixture, preferably in a rubber mixture according to the invention (preferably as described as preferred above).

The present invention additionally relates to a use of the compound according to the invention, preferably as described as preferred above and/or below, as an aging stabilizer and/or antioxidant (preferably as an aging stabilizer), preferably in
vehicle tires, particularly preferably pneumatic vehicle tires;
rubber articles distinct from vehicle tires, particularly preferably selected from the group consisting of air springs, bellows, belts, straps, drive belts, hoses, profiles, seals, membranes, tactile sensors for medical applications, tactile sensors for robotics applications, shoe soles and parts of a shoe sole;
oils and/or greases; and/or
fuels and/or lubricants.

The foregoing relating to the compound according to the invention (including preferred embodiments) and the rubber mixture according to the invention (including preferred embodiments) preferably also applies mutatis mutandis to the use according to the invention as an aging stabilizer and/or antioxidant.

Preferred belts comprise conveyor belts.

In some cases, the use of the compound according to the invention as an aging stabilizer and/or antioxidant in oils, greases, fuels and/or lubricants is preferred, particularly preferably in the context of a use for engines.

The present invention also relates to a use of the rubber mixture according to the invention, preferably as described as preferred above and/or below, for production of a
vehicle tire, preferably a pneumatic vehicle tire, and/or
rubber article distinct from a vehicle tire, particularly preferably selected from the group consisting of air springs, bellows, belts, straps, drive belts, hoses, profiles, seals, membranes, tactile sensors for medical applications, tactile sensors for robotics applications, shoe soles and parts of a shoe sole.

The foregoing relating to the compound according to the invention (including preferred embodiments) and the rubber mixture according to the invention (including preferred embodiments) preferably also applies mutatis mutandis to the use according to the invention for production as described above. The following applies mutatis mutandis preferably also to the vehicle tire according to the invention.

Preference is given to the use for producing any tire components (including external and/or internal components), preferably for producing an external component, particularly preferably for producing a flange profile, tread and/or a sidewall. Particular preference is given to a use for producing a cap of a tread having a cap/base construction. A different shaping during extrusion/calendering preferably determines the type of the component. Preferred internal components comprise a squeegee, an innerliner, a core profile, a belt, a shoulder, a belt profile, a carcass, a bead reinforcement, a bead profile and/or a bandage. Rubber mixtures for internal components are typically also referred to as body mixtures. The different components with their different shapes and in the unvulcanized state are typically used for construction of a green tire. The as-yet unvulcanized green tire is then preferably vulcanized.

The use according to the invention also relates to the production of rubber articles distinct from vehicle tires. These rubber articles preferably have a construction composed of a plurality of plies and particularly preferably one or more than one ply comprises at least one strength member.

Preferred belts comprise rubber belts and/or conveyor belts.

The compound according to the invention, preferably as described as preferred above, is preferably not used as a dye or pigment in pharmaceutical products and in electronic devices respectively (particularly preferably in displays, especially OLED displays).

### Process for Producing the Compound According to the Invention:

The present invention further relates to a process for producing a compound according to the invention, preferably a compound according to formula (I), comprising the process steps of:
i) producing or providing a compound of formula (B1):

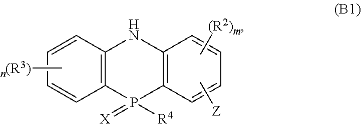

ii) reacting the compound of formula (B1) with
   hydrogen and a ketone or aldehyde, preferably a ketone,
to afford the compound of formula (I):

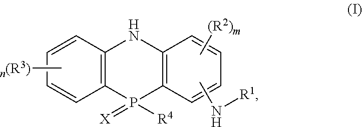

wherein
   R¹ is selected from the group consisting of
      xi) aromatic radicals and
      xii) aliphatic C₃- to C₁₂-radicals,
   R² and R³ are identical or different and independently selected from the group consisting of
      aliphatic C₁- to C₁₂-radicals, aromatic radicals, halogen radicals, cyano radicals, ester radicals, ketone radicals, ether radicals and thioether radicals,
   R⁴ is selected from the group consisting of
      aliphatic C₁- to C₂₀-radicals and aromatic C₅- to C₂₀-radicals,
   X represents oxygen or sulfur, preferably oxygen,
   m is 0 or 1 or 2 or 3,
   n is 0 or 1 or 2 or 3 or 4 and
   Z is selected from the group consisting of halogens, sulfonates, sulfonate-based leaving groups, amino and nitro, preferably of amino and nitro.

The aforementioned relating to the compound according to the invention (preferably and especially to compounds according to the invention defined as preferable hereinabove) preferably also applies mutatis mutandis to the process for production according to the invention. This is to be understood as meaning that all of the foregoing recited in connection with the description of the compound according to the invention, including preferred embodiments and having regard to the possibilities of every level of preference and combination of these features, applies to R¹, R², R³, R⁴, m and n.

It is preferable when in Z the halogens comprise chlorine, bromine or iodine, preferably chlorine. It is particularly preferable when fluorine is not included.

It is preferable when in Z the sulfonate-based leaving groups comprise triflate, nonaflate, mesylate or tosylate.

Z is very preferably nitro or amine, particularly preferably nitro. Accordingly, very preferred starting compounds are corresponding amino or nitro reactants.

Preference is given to a process according to the invention, preferably as described as preferred above and/or below, wherein the reaction in step ii) with hydrogen is carried out using a catalyst, preferably using a hydrogenation catalyst. This means that step ii) preferably uses or employs such a catalyst. In some cases a “hydrogenation catalyst” is also referred to as a “hydrogenation catalyst”, wherein in the context of the present invention both terms have the same definitional scope.

Preference is given to a process according to the invention, preferably as described as preferred above and/or below, wherein in step ii) the catalyst, preferably the hydrogenation catalyst, comprises a metal, preferably one or more than one metal selected from the group consisting of nickel, copper, iron, chromium, aluminum, palladium and platinum. It is particularly preferable when the catalyst, preferably the hydrogenation catalyst, comprises a noble metal, particularly preferably palladium (Pd) and/or platinum (Pt). In other words particular preference is given to a noble metal catalyst.

The metal, preferably the noble metal, is preferably employed on carbon (C). Particularly preferred catalysts comprise palladium on carbon (Pd/C), platinum on carbon (Pt/C), Raney nickel and/or copper chromite, especially preferably palladium on carbon (Pd/C) and/or platinum on carbon (Pt/C).

Preference is given to a process according to the invention, preferably as described as preferred above and/or below, wherein the reaction in step ii) with hydrogen is carried out for a duration of 1 to 30 hours, preferably of 3 to 22 hours, particularly preferably of 5 to 16 hours, especially preferably of 8 to 13 hours.

Preference is given to a process according to the invention, preferably as described as preferred above and/or below, wherein the reaction with hydrogen in step ii) is carried out in a pressure reactor, preferably in an autoclave.

Particular preference is given to a process according to the invention, wherein the reaction in step ii)
is carried out using a catalyst; and/or (preferably and)
is carried out at a temperature of 40° C. to 190° C., preferably of 55° C. to 170° C., particularly preferably of 70° C. to 150° C., especially preferably of 85° C. to 130° C.; and/or (preferably and)
is carried out at a pressure of 20 to 70 bar, preferably of 28 to 57 bar, particularly preferably of 35 to 45 bar.

In the process according to the invention, the ketone in step ii) is the ketone derivative of the subsequent radical R¹; in the case of an aldehyde, it is accordingly the aldehyde derivative. Particular preference is given to a ketone, most preferably methyl isobutyl ketone (MIBK).

Preference is given to a process according to the invention, preferably as described as preferred above and/or below, wherein a solvent is employed in step ii), wherein the solvent is preferably identical to the ketone/aldehyde or is distinct from the ketone/aldehyde (preferably identical).

If the ketone/aldehyde is identical to the solvent the solvent is additionally a reactant. This is preferably the case if the aldehyde/ketone is in liquid form under reaction conditions. If the ketone/aldehyde is not in liquid form under reaction conditions, the solvent is preferably inert, i.e. is itself not a reactant. Preferred inert solvents comprise toluene, a dioxane (preferably 1,4-dioxane), 2-methyltetrahydrofuran (2-MTHF) and/or xylene. This is preferably the case if the aldehyde/ketone is in solid form under reaction conditions. In the latter case, the ketone/aldehyde is preferably employed as reactant only in stoichiometrically necessary amounts (in some cases preferably in slight excess).

Particular preference is given to a process according to the invention, preferably as described as preferred above and/or below, wherein the ketone/aldehyde, particularly preferably the ketone, is in liquid form in step ii), particularly preferably as a solvent and reactant. This makes it possible to dispense with any additional compound, such as toluene or xylene.

Preference is given to a process according to the invention, preferably as described as preferred above and/or below, wherein step ii) is followed by one or more than one purification, preferably a filtration, a chromatography, a recrystallization and/or a washing with a solvent. A preferred solvent which is preferably distinct from the solvent employed in step ii) comprises an alcohol and/or 2-MTHF, preferably methanol and/or ethanol, particularly preferably ethanol. Preference is given to a chromatography comprising silica gel. Preference is given to a recrystallization from hydrocarbons, preferably from C₅ to C₂₀ aliphatic compounds, particularly preferably from cyclohexane and/or cycloheptane.

The invention shall now be more particularly elucidated with the aid of exemplary embodiments.

### Synthesis of a Compound of Formula (I):

The compound of formula (III) as an exemplary embodiment of a compound of formula (I) was prepared in a plurality of steps as specified below:

1st Stage (Synthesis of 5H-phenophosphazinine-10-oxide):

5H-phenophosphazinine-10-oxide was prepared according to M. Haering, Helvetica Chimica Acta, 1960, 43, 1826-1840 and additionally recrystallized from methanol. This afforded a compound of formula (a):

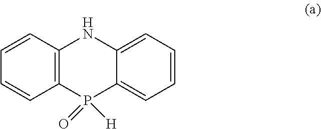 [SMILES: O=[PH]1c2ccccc2Nc2ccccc21]

2nd Stage (10-octyl-5H-phenophosphazinine-10-oxide):

In the 2nd stage, the 5H-phenophosphazinine-10-oxide obtained in the 1st stage was converted into 10-octyl-5H-phenophosphazinine-10-oxide under protective gas, wherein 1.50 g (6.97 mmol, 1 eq) of 5H-phenophosphazinine-10-oxide were dissolved in 30 ml of DMA (dimethylacetamide). 114 mg (0.70 mmol, 0.1 eq) of AIBN (azobis(isobutyronitrile)) and 1.54 ml of 1-octene (9.76 mmol, 1.4 eq) were added thereto and the mixture was heated to 85° C. and left stirring overnight. The solvent was then removed under vacuum. The product, a colourless oil, was obtained in a yield of 2.25 g (99% of theory). A compound of formula (b) was obtained:

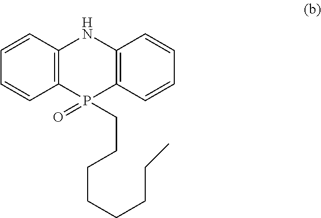 [SMILES: CCCCCCCCP1(=O)c2ccccc2Nc2ccccc21]

¹H-NMR (500 MHz, DMSO-d6) δ=10.07 (s, 1H), 7.75 (ddd, J=11.9, 7.7, 1.5 Hz, 2H), 7.51 (ddd, J=8.5, 7.1, 1.5 Hz, 2H), 7.15 (dd, J=8.3, 5.2 Hz, 2H), 7.08 (td, J=7.4, 1.3 Hz, 2H), 2.09-1.96 (m, 2H), 1.21-0.94 (m, 12H), 0.80 (t, J=7.2 Hz, 3H).

¹³C-NMR (126 MHz, DMSO-d6) δ=142.6, 142.5, 132.9, 130.8, 130.7, 120.7, 120.6, 116.4, 116.3, 112.1, 111.3, 33.2, 31.5, 30.2, 28.8, 25.9, 22.5, 21.4, 14.8.

³¹P-NMR (202 MHz, DMSO-d6) δ=13.7.

Mass spectrometry result: ESI-MS [M+H]⁺=328.

In an alternative synthesis, the compound of formula (b) was prepared according to “Chemistry of phosphorus heterocycles”, M. Tajbakhsh-Jadidi, doctoral thesis, Manchester (1980) (synthesis not further elucidated).

3rd Stage (2-nitro-10-octyl-5H-phenophosphazinine-10-oxide):

At room temperature, 0.95 g (2.90 mmol) of 10-octyl-5H-phenophosphazinine-10-oxide was dissolved in 20 ml of glacial acetic acid. A solution of 2.25 ml of 65% nitric acid and 3.15 ml of glacial acetic acid was added dropwise thereto, the temperature not exceeding 25° C. This formed an orange solution which was poured onto ice after one hour, thus allowing subsequent filtrative removal of a solid. The solid was subsequently dissolved in DCM (alternatively CHCl₃/n-BuOH 3:1) (with optional addition of triethylamine) and extracted with saturated sodium hydride solution and sodium chloride solution. Said solid was dried over sodium sulfate and the inorganic constituents were removed by filtration and the solvent removed under vacuum. The resulting solid was purified by crystallization from 2-MeTHF (in alternative attempts by column chromatography with dichloromethane/methanol; 100:0->95:5). This afforded a compound of formula (c). The compound was obtained as a lemon-yellow solid in a yield of 0.8 g (74% of theory).

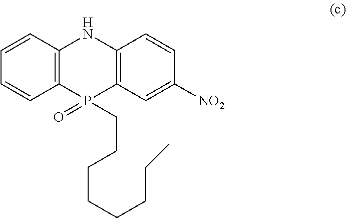 [SMILES: CCCCCCCCP1(=O)c2ccccc2Nc2ccc([N+](=O)[O-])cc21]

¹H-NMR (500 MHz, DMSO-d6) δ=10.92 (s, 1H), 8.62 (dd, J=12.3, 2.7 Hz, 1H), 8.33 (dd, J=9.2, 2.7 Hz, 1H), 7.89-7.81 (m, 1H), 7.63 (t, J=7.7 Hz, 1H), 7.34-7.23 (m, 3H), 2.13 (qq, J=14.7, 6.8, 6.1 Hz, 2H), 1.22-0.97 (m, 12H), 0.80 (td, J=7.3, 3.2 Hz, 3H).

¹³C-NMR (126 MHz, DMSO-d6) δ=147.1, 141.1, 140.2, 133.6, 131.0, 128.3, 128.0, 123.0, 117.5, 112.8, 112.1, 111.4, 31.5, 30.0, 29.9, 28.7, 28.6, 22.5, 22.2, 14.3.

³¹P-NMR (202 MHz, DMSO-d6) δ=13.91.

Mass spectrometry result: ESI-MS [M+H]⁺=373.

4th Stage (2-(1,3-dimethylbutylamino)-10-octyl-5H-phenophosphazinine-10-oxide):

163 mg (0.44 mmol) of 2-nitro-10-octyl-5H-phenophosphazinine-10-oxide, 37 mg of platinum on carbon (5%; 0.4 g on 4.67 mmol of substrate) and 20.0 ml of methyl isobutyl ketone (MIBK) were weighed into a stainless steel autoclave fitted with a Teflon inliner. The reaction mixture was subsequently subjected to hydrogen at a pressure of 40 bar and stirred at 120° C. for 10 hours. After termination of the reaction the excess hydrogen was released. The reaction product obtained was a suspension which was filtered through celite and subsequently washed with ethanol. The resulting filtrate was concentrated to dryness and then dried further under vacuum. The resulting dried product was purified by crystallization from cyclohexane. The purified product obtained was a violet-brown solid; yield 155 mg (83% of theory). This afforded the compound according to formula (III).

¹H-NMR (500 MHz, DMSO-d6) δ=9.66 (s, 1H), 7.67 (dd, J=11.9, 7.7 Hz, 1H), 7.45-7.39 (m, 1H), 7.05 (dd, J=8.4, 5.3 Hz, 1H), 6.96 (q, J=7.6 Hz, 2H), 6.85 (d, J=29.3 Hz, 2H), 4.27 (s, 1H), 3.09 (qd, J=7.3, 4.8 Hz, 1H), 1.93 (ddd, J=15.1, 9.9, 5.9 Hz, 2H), 1.71 (dddt, J=19.5, 13.1, 8.2, 6.6 Hz, 2H), 1.45 (dtd, J=13.7, 7.1, 3.1 Hz, 1H), 1.18 (td, J=7.2, 2.7 Hz, 2H), 1.09 (dt, J=10.2, 6.2 Hz, 8H), 0.93 (d, J=6.6 Hz, 3H), 0.88 (dd, J=6.6, 4.9 Hz, 2H), 0.87-0.83 (m, 6H), 0.80 (td, J=7.2, 1.1 Hz, 3H).

³¹P-NMR (202 MHz, DMSO-d6) δ=14.37.

Mass spectrometry result: ESI-MS [M+H]⁺=427.

### Further Compounds of Formula (I):

In an alternative synthesis based on “Chemistry of phosphorus heterocycles”, M. Tajbakhsh-Jadidi, doctoral thesis, Manchester (1980), a compound of formula (II) was prepared in a manner analogous to the procedure described above, wherein n and m are zero, R¹ is dimethylbutyl and R⁴ is phenyl (synthesis not further elucidated).

### Measurement of Oxidation Induction Time (OIT)

The compound of formula (III) was investigated under laboratory conditions for its potential protective effect as an aging stabilizer/antioxidant by measurement of the oxidation induction time.

To this end, the compound of formula (III) and, for comparison, 6PPD, in each case together with a polymer (liquid synthetic polyisoprene (IR), LIR-50, Kuraray, weight average molecular weight distribution M_{w}=54 000 g/mol, glass transition temperature T_{g}=−63° C.), were heated at 180° C. until onset of oxidation. The time required for this is the aforementioned “oxidation induction time” in the context of the present invention.

### Heating to 180° C.:

Starting temperature 35° C., initially heating to 170° C. at a heating rate of 20 K/min (kelvin per minute), then further heating to 180° C. at a heating rate of 1 K/min (purge gas: nitrogen (N₂), volume flow 50 ml/min).

The specimen was kept under isothermal conditions at 180° C. under an N2 atmosphere for 5 minutes and the atmosphere was then switched to an 02 atmosphere (volume flow 50 ml/min).

### Heating to 150° C.:

The heating to 150° C. was carried out analogously by first heating to 140° C. at a heating rate of 20 K/min (kelvin per minute) and then heating to 150° C. at a heating rate of 1 K/min.

Oxidation was observed by DSC (differential scanning calorimetry). The time in minutes until onset of oxidation was measured in each case. The results compared to the known aging stabilizer 6PPD are summarized in table 1.

TABLE 1
oxidation induction time in [min]

| Compound | Time [min] (180° C.) | Time [min] (150° C.) |
|---|---|---|
| 6PPD | 116 | 943 |
| Formula (III) | 87 | 673 |

Table 1 shows that, at a temperature of 180° C. considered particularly demanding, the compound of formula (III) shows a sufficient to good protective effect compared to 6PPD, namely of about 75%. This also applies to a temperature of 150° C. (about 71%). The potential protective effect is therefore to be given an overall rating of good.

The compounds of formula (I) in general and of formula (III) in particular are based on a phenophosphazinine or phenophosphazinine-10-oxide basic structure. By comparison, 6PPD is based on a diphenylamine basic structure. However, phenophosphazinine derivatives are potentially less hazardous to the environment and health. The compound/compound class according to the invention additionally achieves an entirely sufficient protective effect.

The compound according to the invention of formula (III) as a representative of the compound according to the invention of formula (I) also exhibits sufficient solubility in rubber mixtures.

For use (as particularly preferred here) in a rubber mixture for vehicle tires, the compound according to the invention of formula (I), represented by a compound of formula (III), is added in one of the mixing stages during production of the rubber mixture in a manner known to those skilled in the art, for example instead of the aging stabilizers known in the prior art, such as 6PPD, 7PPD or IPPD etc.

To this end, the compound of formula (III) is incorporated in different amounts for example (see table 2). The resulting inventive examples are identified as E1 and E2.

Comparative examples are rubber mixtures containing 6PPD instead of the compound of formula (III) as aging stabilizer at otherwise identical composition, with substitution in each case on a mole-per-mole basis between V1 and E1 and V2 and E2. The amounts in table 2 are reported in units of phr. A reference (Ref.) without aging stabilizer is also reported.

In all mixtures, the amounts of aging stabilizer (6PPD or compound of formula (III)) and plasticizer oil MES sum to 10 phr.

TABLE 2
exemplary rubber mixtures [phr]

| Constituent | V1 | E1 | V2 | E2 | Ref. |
|---|---|---|---|---|---|
| NR | 100 | 100 | 100 | 100 | 100 |
| N 339 carbon black | 50 | 50 | 50 | 50 | 50 |
| MES | 8.0 | 7.7 | 5.0 | 4.2 | 10 |
| 6PPD | 2.0 | — | 5.0 | — | — |
| Compound of formula (III) | — | 2.3 | — | 5.8 | — |
| ZnO | 3 | 3 | 3 | 3 | 3 |
| Stearic acid | 2 | 2 | 2 | 2 | 2 |
| TBBS | 1.2 | 1.2 | 1.2 | 1.2 | 1.2 |
| Sulfur | 1.2 | 1.2 | 1.2 | 1.2 | 1.2 |

The examples of rubber mixtures according to the invention also show a comparatively sufficient aging stabilization effect compared to typical rubber mixtures, especially those known from the prior art (data not shown). By contrast, the reference shows an aging stabilization effect which is altogether inadequate.

1. A compound of formula (I): 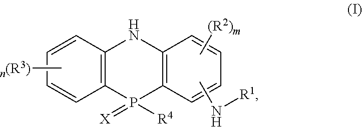
wherein
R¹ is selected from the group consisting of
xi) aromatic radicals and
xii) aliphatic C₃- to C₁₂-radicals,
R² and R³ are identical or different and independently selected from the group consisting of aliphatic C₁- to C₁₂-radicals, aromatic radicals, halogen radicals, cyano radicals, ester radicals, ketone radicals, ether radicals and thioether radicals,
R⁴ is selected from the group consisting of aliphatic C₁- to C₂₀-radicals and aromatic C₅- to C₂₀-radicals,
X represents oxygen or sulfur,
m is 0 or 1 or 2 or 3 and
n is 0 or 1 or 2 or 3 or 4.

2. The compound as claimed in claim 1, wherein said compound has the structure of formula (II): 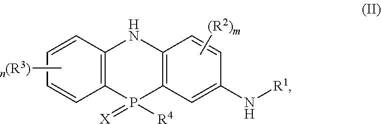
wherein R¹, R², R³, R⁴, X, m and n are as already defined.

3. The compound as claimed in claim 1, wherein n and m are identical or different, preferably identical.

4. The compound as claimed in claim 1, wherein n and m are zero.

5. The compound as claimed in claim 1, wherein R⁴ is an aromatic C₅- to C₁₈-radical, preferably an aromatic C₅- to C₁₆-radical, more preferably an aromatic C₅- to C₁₄-radical, particularly preferably an aromatic C₆- to C₁₂-radical, very particularly preferably an aromatic C₆- to C₁₀-radical.

6. The compound as claimed in claim 1, wherein R⁴ is an aliphatic C₁- to C₁₈-radical, preferably an aliphatic C₂— to C₁₆-radical, more preferably an aliphatic C₃- to C₁₄-radical, particularly preferably an aliphatic C₄- to C₁₂-radical, very particularly preferably an aliphatic C₅- to C₁₀-radical.

7. The compound as claimed in claim 1, wherein R⁴ is heptyl, octyl, nonyl, benzyl or phenyl.

8. The compound as claimed in claim 1, wherein R¹ is 1,3-dimethylbutyl, benzyl or cyclohexyl, preferably 1,3-dimethylbutyl.

9. The compound as claimed in claim 1, wherein said compound has the structure of formula (III):

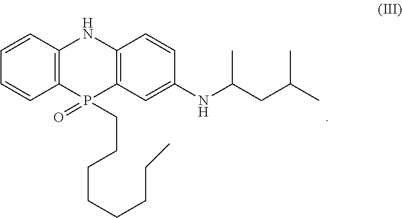 [SMILES: CCCCCCCCP1(=O)c2ccccc2Nc2ccc(NC(C)CC(C)C)cc21]

10. A rubber mixture containing the compound as claimed in claim 1, the rubber mixture comprising one or more than one diene rubber.

11. A vehicle tire, preferably a pneumatic vehicle tire, which comprises the rubber mixture as claimed in claim 10 in at least one component, preferably in at least one external component, wherein the external component is preferably a tread, a sidewall and/or a flange profile.

12. A method of using the compound as claimed in claim 1 comprising providing the compound and using the compound as an aging stabilizer and/or antioxidant, preferably in
vehicle tires, particularly preferably pneumatic vehicle tires,
rubber articles distinct from vehicle tires, particularly preferably selected from the group consisting of air springs, bellows, belts, straps, drive belts, hoses, profiles, seals, membranes, tactile sensors for medical applications, tactile sensors for robotics applications, shoe soles and parts of a shoe sole,
oils and/or greases and/or
fuels and/or lubricants.

13. A method of using the rubber mixture as claimed in claim 10 comprising providing the rubber mixture and using the rubber mixture for producing a
vehicle tire, preferably a pneumatic vehicle tire, and/or
rubber article distinct from a vehicle tire, particularly preferably selected from the group consisting of air springs, bellows, belts, straps, drive belts, hoses, profiles, seals, membranes, tactile sensors for medical applications, tactile sensors for robotics applications, shoe soles and parts of a shoe sole.

14. A process for producing a compound of formula (I), comprising the process steps of:
i) producing or providing a compound of formula (B1): 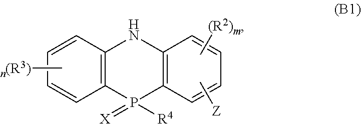
ii) reacting the compound of formula (B1) with
hydrogen and a ketone or aldehyde, preferably a ketone,
to afford the compound of formula (I): 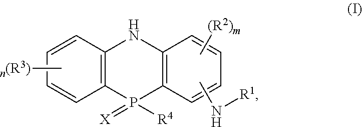
wherein
R¹ is selected from the group consisting of
xi) aromatic radicals and
xii) aliphatic C₃- to C₁₂-radicals,
R² and R³ are identical or different and independently selected from the group consisting of aliphatic C₁- to C₁₂-radicals, aromatic radicals, halogen radicals, cyano radicals, ester radicals, ketone radicals, ether radicals and thioether radicals,
R⁴ is selected from the group consisting of aliphatic C₁- to C₂₀-radicals and aromatic C₅- to C₂₀-radicals,
X represents oxygen or sulfur,
m is 0 or 1 or 2 or 3,
n is 0 or 1 or 2 or 3 or 4 and
Z is selected from the group consisting of halogens, sulfonates, sulfonate-based leaving groups, amino and nitro, preferably of amino and nitro.

15. The process as claimed in claim 14, wherein the reaction in step ii)
is carried out using a catalyst and/or
is carried out at a temperature of 40° C. to 190° C., preferably of 55° C. to 170° C., particularly preferably of 70° C. to 150° C., especially preferably of 85° C. to 130° C. and/or
is carried out at a pressure of 20 to 70 bar, preferably of 28 to 57 bar, particularly preferably of 35 to 45 bar.
